(19) United States
(12) Patent Application Publication
(10) Pub. No.: US 2018/0230053 A1
(43) Pub. Date: Aug. 16, 2018

(54) CASTABLE MATERIAL BASED ON CEMENTITIOUS MATERIAL WITH SHRINKAGE RESISTANCE

(71) Applicant: CEMEX RESEARCH GROUP AG, Brugg Bei Biel (CH)

(72) Inventors: Jessica CHIAVERINI, Bienne (CH); Wolfgang SALMEN, Büren (DE); Davide ZAMPINI, Lyss (CH)

(21) Appl. No.: 15/751,004

(22) PCT Filed: Aug. 7, 2015
(86) PCT No.: PCT/IB2015/056025

§ 371 Date: Feb. 7, 2018

(51) Int. Cl. C04B 24/38; C04B 28/04; C04B 14/06; C04B 24/24

(52) U.S. Cl. CPC C04B 24/38; C04B 28/04; C04B 2103/0051; C04B 24/24; C04B 14/06

(57) ABSTRACT

Some embodiments are directed to a new castable cement based material containing a special admixture based internal curing system to reduce the shrinkage and avoid the formation of cracks, and method of producing the same.

### CROSS REFERENCE TO RELATED APPLICATIONS

This application is a national phase filing under 35 C.F.R. § 371 of and claims priority to PCT Patent Application No. PCT/IB2015/056025, filed on Aug. 7, 2015, the content of which is hereby incorporated in its entirety by reference.

### BACKGROUND

Some embodiments relate to concrete or mortar mix formulations containing a special admixture-based internal curing system to reduce the shrinkage (plastic drying and autogenous) and avoid the formation of cracks.

Cracks formation due to shrinkage of concretes during hydration and hardening are a common occurrence in concrete and they can be structural (which endanger the safety and durability of the construction, occurring due to an incorrect mix design, errors during construction and/or over loading) or non-structural (which don't jeopardize the safety of the construction, mostly due to internally induced stresses). Nevertheless, even non-structural cracking should be avoided, since moisture penetration through such cracks may result in corrosion of the structure, resulting in a weaker structure and poor aesthetics.

Thermal changes, wind, chemical reactions or moisture differences, for example, cause internal stress in the concrete structure, leading to dimensional adjustments, for example concrete shrinkage; when the movement for the adjustment is restricted, cracks may form.

### SUMMARY

Several types of shrinkage may occur in concrete, namely:
Plastic shrinkage, which is the volumetric contraction that concrete undergoes after being placed, still in fresh (or plastic) state, before setting. If the concrete surface loses bleed water faster than the rate of bleeding, it dries quicker, resulting in a tension that leads to cracks.
Drying shrinkage, caused by the loss of excess water. The chemical reaction that causes concrete to go from a liquid or plastic state into a solid state (hydration) consumes water. To assure the workability of fresh concrete, it is a normal procedure to add to the concrete mix a higher quantity of water than the one strictly needed for the hydration process. This water in excess will not be part of the hydrated product and will escape the network while the product gets stiff, leading to concrete shrinkage. Surface and/or internal restrictions, such as, for example, the reinforcement in use, the formwork, the subgrade, etc., provoke different shrinkage rates and tension stress in different directions, which finally leads to concrete cracking.
Autogenous shrinkage, which occurs at low water to binder ratios, less than about 0.42. At this low water/binder ratio, all the water is rapidly used in the hydration process, creating a water deficit which leads to the appearance of fine capillaries. The surface tension within the capillaries may lead to cracking.
Thermal shrinkage, which is explained on the premise that solids expand on heating and contract on cooling. When free to deform, concrete will expand or contract due to temperature oscillations. If the concrete structure is held in place or restrained, for example, by internal reinforcement, temperature changes may create stress and cause the concrete to crack.
Carbonation shrinkage, which occurs when the concrete is exposed to atmospheric CO₂. The CO₂ reacts with hydrated cement, namely with Ca(OH)₂, which is converted to CaCO₃. This reaction, called carbonation, leads to an increase in weight of the concrete and to its shrinkage.

The curing process is an essential step when concrete is placed. A proper curing of the concrete is needed to avoid the rapid drying of the product and consequently to avoid the formation of cracks. Curing avoids water loss and is normally done by spraying or sprinkling water over the concrete surface for days to ensure that the surface is permanently moist or by covering the surface with a water tight film. This prevents the concrete's moisture from evaporating, contributing to the strength gain of the product and prevents the appearance of cracks, yet these operations are time consuming and costly.

The chemical reaction that causes concrete to go from a liquid or plastic state into a solid state (hydration) consumes water. Although the theoretical minimum water content with respect to the quantity of cement is 25% weight, a slight excess is used to improve workability of the product. However, excess of water is prejudicial to the final product. Before hardening, the concrete is full of water, which fills in the space between the solid ingredients, making the slab a certain size. As the hydrated cement paste loses moisture from its pores, the slab gets smaller. If an excess of water is used in the mix, the shrinkage will be greater than if the correct amount of water is used. Shrinkage is the main cause of cracking, since it will create forces in the concrete that will drag the slab apart, provoking cracks to happen.

Several factors impact shrinkage, for example: the cement and water content, size of the aggregates, aggregate to cement ratio, excessive fines, admixtures, cement composition, temperature, humidity, curing process, etc.

Particularly, the so called shrinkage-reducing and shrinkage-compensating admixtures have been proven efficient against drying shrinkage. While shrinkage-reducing admixtures are believed to reduce shrinkage by modifying the surface tension of capillary pore water, shrinkage-compensating materials help the concrete to expand at the same volume that drying shrinkage contracts it through specific chemical reactions, the most relevant leading to the formation of ettringite or calcium hydroxide.

Fibres are an example of a material that can help in reducing the risk of concrete cracking by the increase of the crack opening resistance, therefore resulting in reduced crack opening. Therefore, fibers and shrinkage-reducing admixtures can be used individually but also combined.

Shrinkage-compensating materials and shrinkage-reducing admixtures are already known in the art. Whilst the first are normally based on calcium sulfo-aluminate or calcium aluminate and calcium oxide, the later are normally based on polyoxyalkylene alkyl ethers or propylene glycol. Also the usage of fibres and superabsorbent polymers (SAPs) has been shown effective against concrete shrinkage. Fibers help in reducing the risk of concrete cracking by increasing the crack opening resistance.

SAPs, broadly speaking, are cross-linked polymer networks that will swell when in contact with water or aqueous solutions, forming a gel, and will release the liquid gradually over time when exposed to dry conditions. SAPs are able to absorb amounts of water a few hundred times their own weight, hence their use as concrete additives for internal curing.

However, SAPs exhibit a number of disadvantages that hamper the scope of their use, and their applicability in industrial applications, such as in the broad field of the construction industry. Namely, SAPs are typically used in powder form in part due to their poor water solubility, and are therefore notoriously more difficult to dose, particularly because SAPs, due to their hygroscopic properties, will easily absorb water from the environment, especially in such a non-confined environment such as that from a cement plant.

For example, it is known that the addition of SAP in concrete results in the reduction of plastic and autogenous shrinkage and also modifies the concrete's microstructure, especially its pore structures. It is believed that this happens because, when SAPs absorb water, they act as soft aggregates in the concrete but when the water is released, they act as air voids; also, the water absorption of SAPs affect the effective water-cement ratio in the early hydration phase.

These effects are mainly due because SAPs are added to the concrete or mortar mixes as powder, which renders very difficult to control and predict the SAP water uptake and behaviour. As such, the SAP will uptake mixing water from the mix, thereby reducing workability of the mortar/concrete.

Publications exist disclosing the use of SAP as shrinkage-reducers and/or internal curing agents, nevertheless SAPs are added as powder to dry mixes, and exhibit the same disadvantages presented above.

For example, US 2014/0371351 discloses a dry mix to be used in the construction industry based on a mineral binder including at least one SAP, an accelerator and one source of aluminium ion, in order to produce a good compromise between lightweight and mechanical properties. Yet, it was observed in the field that the use of dry compositions including SAPs lead to workability problems once water is added, due to the water uptake by the SAPs.

WO 2013/156590 discloses a freeze-thaw damage resistance admixture that includes an aqueous slurry including a water insoluble superabsorbent polymer. However, having a slurry is not suitable for real life applications due to poor dispersion of the SAPs and also because the polymers will sink into the slurry, separating from the liquid, leading to a poor shelf life of the material.

U.S. Pat. No. 6,187,887 discloses water-soluble or water-swellable copolymers containing sulfonic groups and based on (meth)acrylamide or N-vinyl compounds, which are used for increasing water retention in construction materials. US'887 discloses a method to prepare such water-soluble or water-swellable copolymers, the choice of SAPs being constrained by the limited range of options given. However, the complexity of the method is not practical for industrial scale applications. In addition, US'887 does not address nor solve the aforementioned problems related to the addition of SAPs in solid form to concrete mixes, in the construction industry.

In summary, adding SAPs as powder into dry cementitious mixes is not a viable solution for industrial applications, since it is very difficult to predict the water uptake by the SAP. This inevitably leads to workability issues at the job site, resulting in very stiff mixes that will originate severe problems when the final product has to be casted and placed, such as premature hardening of the mix inside the mixing drum.

It may therefore be advantageous to address or overcome the problems or challenges discussed above with regard to the related art, and notably to develop SAPs having excellent properties as internal curing agents for mortars and/or concretes, but lacking or reducing at least one of the drawbacks of existing products (e.g;, unpredictable/uncontrollable water uptake, poor workability of the cement/mortar, and premature hardening of the mix).

The inventors have now developed a new SAP formulation addressing and/or overcoming the aforementioned problems. Specifically, some embodiments are directed to a cementitious material mix design with reduced risk of cracking due to plastic, drying and/or autogenous shrinkage. Particularly, some embodiments are directed to a concrete and/or mortar formulation with high resistance to shrinkage, wherein an internal curing system based on an aqueous mix of superabsorbent polymers is used.

### Definitions

As used herein, “Hydraulic binder” refers to a material with cementing properties that sets and hardens due to hydration even under water. Hydraulic binders produce calcium silicate hydrates also known as CSH.

As used herein, “Cement” refers to a binder that sets and hardens and bring materials together. The most common cement is the ordinary Portland cement (OPC) and a series of Portland cements blended with other cementitious materials.

As used herein, “Ordinary Portland cement” refers to a hydraulic cement made from grinding clinker with gypsum. Portland cement contains calcium silicate, calcium aluminate and calcium ferroaluminate phases. These mineral phases react with water to produce strength.

As used herein “Portland clinker” refers to the basic component of cement produced by the clinker manufacturing kiln, without any addition of gypsum, limestone or any other cementitious materials.

As used herein, “Mineral addition” refers to a mineral admixture (including the following powders: silica fume, fly ash, slags) added to concrete to enhance fresh properties, compressive strength development and improve durability.

As used herein, “Silica fume” refers to a source of amorphous silicon obtained as a byproduct of the silicon and ferrosilicon alloy production. Also known as microsilica.

As used herein, “Total binder” refers to the sum of all cementitious components (cement, flay ash, slag, silica fume, etc.) by weight.

As used herein, “Volume of paste” refers to the total volume of the cement, +fly ash+slag+silica fume+water+entrained air+filler (micro-silica or micro-limestone)+water+entrained air (following densities in Kg/Liter are used: cement type 13.15 type II 3.0, fly ash: 2.1, Ground Granulated Blast Furnace Slag: 2.15, fillers 2.8, silica fume: 0.5, water: 1).

As used herein, “Fibers” refers to a material used to increase concretes structural performance. Fibers include: steel fibers, glass fibers, synthetic fibers and natural fibers.

As used herein, “Alumino silicate—by-product (Fly Ash—bottom ash)” refers to an alkali reactive binder components that together with the activator form the cementitious paste. These are minerals rich in alumina and silica in both, amorphous and crystalline structure.

As used herein, “Natural pozzolan” refers to an aluminosilicate material of volcanic origin that reacts with calcium hydroxide to produce calcium silicate hydrates or CSH as known in Portland cement hydration.

As used herein, “Inert filler” refers to a material that does alter physical properties of concrete but does not take place in hydration reaction.

As used herein, “Admixture raw material” refers to a chemical component in an admixture formulation system of one main chemical polymer.

As used herein, “Admixture” refers to chemical admixtures used to modify or improve concrete's properties in fresh and hardened state. These could be air entrainers, water reducers, set retarders, accelerators, stabilizers, superplasticizers and others.

As used herein, “Air entrained” refers to the total volume of air entrained in the concrete by the air entrainer.

As used herein, “PCE” refers to Polycarboxylic Acid Co-Polymers used as a class of cement and concrete admixtures, and are comb type polymers that are based on: a polymer backbone made of acrylic, methacrylic, maleic acid, and related monomers, which is grafted with polyoxyalkylene side-chain such as EO and/or PO. The grafting could be, but is not limited to, ester, ether, amide or imide.

As used herein, “Initial dispersant” refers to a chemical admixtures used in hydraulic cement compositions such as Portland cement concrete, part of the plasticizer and superplasticizer family, which allow a good dispersion of cement particles during the initial hydration stage.

As used herein, “Superplasticizers” refers to a class of chemical admixture used in hydraulic cement compositions such as Portland cement concrete having the ability to highly reduce the water demand while maintaining a good dispersion of cement particles. In particular, superplasticizers avoid particle aggregation and improve the rheological properties and workability of cement and concrete at the different stage of the hydration reaction.

As used herein, “Concrete” refers to, primarily, a combination of hydraulic binder, sand, fine and/or coarse aggregates, water. Admixture can also be added to provide specific properties such as flow, lower water content, acceleration, etc.

As used herein, “Castable construction materials” refers to a material is consider as pourable as soon as its fluidity (with our without vibration) allow to full fill a formwork or to be collocate in a definite surface.

As used herein, “Construction materials” refers to any materials that can be use to build construction element or structure. It includes concrete, masonries (bricks-blocks), stone, ICF. etc.

As used herein, “Structural applications” refers to a construction material is consider as structural as soon as the compressive strength of the material is greater than 25 MPa.

As used herein, “Workability” refers to the workability of a material which is measured with a slump test (table 1: slump).

As used herein, “Workability retention” refers to the capability of a mix to maintain its workability during the time. The total time required depends on the application and the transportation.

As used herein, “Workability retention” refers to the capability of a mix to maintain its workability during the time. The total time required depends on the application and the transportation.

As used herein, “Internal Curing admixture” refers to the capability of a mix to maintain its workability during the time. The total time required depends on the application and the transportation.

As used herein, “Internal Curing admixture” refers to an admixture agent that retains water and release the eater internally in a delayed matter to compensated form water depletion due to drying.

As used herein, “Strength development—setting/hardening” refers to the setting time start when the construction material change from plastic to rigid. In the rigid stage the material cannot be poured or moved anymore. After this phase the strength development corresponding to the hardening of the material.

As used herein, “Coarse aggregates” or gravel refers to manufactured, natural or recycled minerals with a particle size greater than 6 mm and a maximum size lower than 32 mm (typically 8-16 mm, 8-25 mm, 10-32 mm, 6-16 mm, etc.).

As used herein, “Fines aggregates” refers to manufactured, natural or recycled minerals with a particle size typically greater than 2 mm and a maximum size lower than 12 mm. (typically 4-8 mm, 2-8 mm, 3-10 mm, etc.)

As used herein, “Sand aggregates” refers to manufactured, natural or recycled minerals with a particle size lower than 3 or 4 mm.

As used herein, “Ductility” refers to the capacity of the concrete to deform in a none elastic way, keeping resistances expressed by residual strength a certain displacement (CMOD) according to norm EN 14651.

As used herein, “Flexural strength” refers to the strength measured on 3 points bending tests (notched prismatic samples 500 mm×150 mm×150 mm) according to norm EN 14651.

As used herein, “Ultimate strength (US)” refers to the ultimate strength of the fibers before rupture.

As used herein, the water to binder ratio “w/b” refers to the total free water (w) mass in Kg divided by the total binder mass in Kg.

As used herein, “Shrinkage reducing admixtures” refers to products aimed at reducing the amount of shrinkage that occurs in concrete.

As used herein, “Shrinkage” refers to the reduction in the volume of concrete caused by the loss of moisture as concrete hardens or dries. Because of the volume loss, concrete shrinkage can lead, for example, to cracking when base friction or other restraint occurs.

As used herein, “Superabsorbents” refers to polymeric materials that have the ability to absorb a large amount of liquid from the surroundings and retain it within their structure. They can ensure internal curing very efficiently.

Some embodiments are directed to a technical solution to produce crack resistant concrete or mortar mix designs due to a formulated internal curing system that provides the final material with a higher resistance to shrinkage (plastic, drying and/or autogenous shrinkage). The final cementitious material is suitable for an array of applications, including but not limited to pavements, slabs, screeds, decorative and/or architectonic.

Due to the disclosed internal curing system formulation, one can significantly lower the need for external curing, greatly reducing the frequency for spraying and/or sprinkling the final material's surface after placement with water. Finally, no reduction in workability is observed, the final cementitious material obtained from the formulation hereby disclosed having the final desired consistency according to the application, which can range from S3 to SF3 (cf. Tables 1 and 2), without risk of segregation and being able to maintain the consistency during the time for placement.

TABLE 1
Consistency of concrete from European Norm
(slump tests according to EN 12350-2)
EN 206 2013 (§ 4.2-table 3)

| Consistency | slump [mm] |
|---|---|
| S1 | 10 to 40 |
| S2 | 40 to 90 |
| S3 | 100 to 150 |
| S4 | 160 to 210 |
| S5 | >220 |

TABLE 2
Consistency of fluid concrete from European Norm
(slump tests according to EN 12350-2)
EN 206 2013 (§ 4.2.1 table 6)

| category | Flow [mm] |
|---|---|
| SF1 | 550-650 |
| SF2 | 660-750 |
| SF3 | 760-850 |

As such, some embodiments are directed to a cementitious material mix design, including:
(a) a cementitious binder that contains an Ordinary Portland Cement, wherein the binder content per cubic meter of fresh produced castable material (concrete or mortar) is at least 290 kg;
(b) sand, wherein the sand content per cubic meter of fresh concrete or mortar is between 500 kg and 1600 kg;
(c) water, wherein the water to total binder ratio is between 0.25 and 0.7 by weight;
(d) a self-curing system; and
(e) a volume of paste in an amount of at least 250 I per cubic meter of fresh concrete or mortar;
wherein,
   the internal curing system includes a mixture of a superabsorbent polymer, a viscosity modifier and an inorganic salt, in water.

Without wishing to be bound be any particular theory, it is submitted that having the SAP in a stabilized aqueous mix ensures that the polymers would not absorb a considerable amount of the castable material's mixing water, consequently not affecting the final water to binder ratio, preserving the workability of the mix, but still being capable of acting as internal curing agents for mortars and/or concretes.

Achieving a stabilized aqueous SAP mix is a rather thorny endeavour due to the polymers' notorious low water solubility: although having high affinity for water, SAPs are not water soluble and precipitate in an aqueous solution, therefore impairing their use in real, industrial applications. That is why the related art has not so far considered stabilized aqueous SAP mixes, much less their use as an internal curing system that can be added to mortar and/or concrete as shrinkage-reducer admixture and/or internal curing agent.

Advantageously, the average quantity of internal curing system dry solid content added is typically between 0.1 kg and 25 kg per cubic meter of fresh produced castable material (concrete or mortar), wherein the dry solid content of the internal curing system added is between 0.2% and 2.2%, wherein the dry solid content is expressed in weight % with respect to the total binder.

In a possible or preferred embodiment, the internal curing system is first formulated and added afterwards as a stabilized aqueous suspension to a cementitious material mix of binder containing mainly Portland cement, water, sand and optionally mineral additions, as well as, also optionally, fine and/or coarse aggregates.

Advantageously, the internal curing system herein disclosed uses a superabsorbent polymer which is suspended in water and is formulated as an aqueous stabilized suspension, having a shelf-life from a couple of weeks up to a maximum of 5-6 months, in normal warehouse conditions (temperatures between 15t to 35° C.).

Advantageously, the formulated internal curing system includes a superabsorbent polymer (SAP) stabilized in an aqueous suspension, also including an inorganic salt and a viscosity modifier agent.

Advantageously, to formulate the internal curing system, the viscosity modifier agent is mixed with water. The viscosity modifier agent acts as a stabilizer; it prevents the sedimentation of the superabsorbent polymer: by increasing the viscosity of the formulation, the velocity of particle sinking is reduced.

Accordingly, some embodiments are directed to a process for preparing an internal curing system according to the presently disclosed subject matter, including:
mixing a viscosity modifier agent with water;
adding a suitable inorganic salt and mixing for a time t that is at least 30 minutes; and
adding the superabsorbent polymer to form an aqueous suspension.

Shortening the time t to less than 30 minutes will yield poor dissolution of the inorganic salt in the water, thus limiting the interaction of the inorganic salt with the SAP and as a result enabling the SAP to incorporate too much water, forming a gel that cannot be used for the purpose of some embodiments.

Possibly or preferably, the viscosity modifier agent is selected from polysaccharides (cellulose ether, starch, alginate, egg yolk, agar, arrowroot, carageenan, collagen, gelatin, guar gum, welan gum, gellan gum, diutan gum, pullulan pectin and xanthan gum, etc.) or synthetically derived viscosity modifiers, including polymers of acrylic acid and co-polymers thereof, polyethylene and related copolymers (for example, ethylene-vinyl acetate copolymer) alkylene oxide polymers and esters thereof (for example Poly(ethylene glycol) ester) and methyl vinyl ether/maleic anhydride copolymers crosslinked with decadiene.

Advantageously, the viscosity modifier agent may be constantly stirred in water, the mixing preferably being at least 1 hour.

After the mixing of water and viscosity modifier agent is finalized, the inorganic salt may be added. Possibly or preferably, the valence of the inorganic salt cation may be between +1 to +3 and the cation may be chosen from: Sodium (Na⁺), Potassium (K⁺), Calcium (Ca²⁺) or Aluminium (Al³⁺). More preferably, the inorganic salt cation has a valence of at least +2, for example the cation is Ca²* or Al³⁺.

Without wishing to be bound by any particular theory, it is submitted that the presence of electrolytes diminishes the absorption capacity of the SAP. The dissolved cations of the inorganic salt will form ionic bonds with the anionic charges of the SAP, reducing the osmotic pressure in the solution. Polyvalent cations, with a valence of at least 2+ will form extra ionic bonds with the structure of the SAP, reducing the water uptake capacity of the SAP. Thus, some embodiments ensure that the SAP in the aqueous medium will not be completely saturated and consequently completely gelled, thus still warranting the handling of the mix, including dosage and pouring into the cementitious mix.

For example, the inorganic salt used can be aluminium sulphate (Al₂(SO₄)₃) or calcium sulphate (CaSO₄). While the cations Ca²⁺ or Al³⁺ ensure cross bonding within the SAP, the sulphate ion shows little interaction with the cement (concrete or mortar) in the dosages/amounts disclosed in some embodiments. Additionally, the sulphate helps to reduce the pH value, contributing to the reduced water absorption by the SAP. Further, sulphate is an ion commonly found in cement compositions, coming from calcium sulphate that is finely grounded with the clinker in the cement production process. Calcium sulphate is present in the cement powder to avert the flash settings of the cement, as well as to facilitate the grinding of the clinker, since it prevents the adherence of the powder to the surface of the milling equipment.

In addition, calcium nitrate and sodium nitrate could be used as inorganic salts in the formulation of the internal curing system according to some embodiments of the presently disclosed subject matter. However, these nitrate salts are somewhat less referred since the use of nitrates is restricted in some countries. Similarly, also chloride ion should be avoided when selecting the inorganic salt, since Cl⁻ present in the final product will contribute to the corrosion of the metallic rebars used in the construction industry.

Advantageously, the mixing time between the inorganic salt and the water—viscosity modifier agent mix should be at least 30 minutes. Then, the SAP can be added to the solution.

Any SAP will be suitable according to some embodiments. Preferably, the SAP may be a crosslinked anionic polyelectrolyte with a highly negative charge, possibly or preferably a range of anionic groups included between 20% and 60% of the total of groups (anionic plus cationic) present in the molecule for example anionic crosslinked copolymers of acrylamide and potassium acrylate. Potassium-based SAPs are found to be more robust in concrete under alkaline conditions. Advantageously, the superabsorbent polymer in the internal curing system is a potassium-based superabsorbent.

Advantageously, the polymers suspended in the formulated internal curing system have about 3% weight to 25% weight of water absorbed in their structure, wherein the 100% weight relates to a completely saturated polymer, due to the action of the electrolytes in the formulation, already described above.

Advantageously, the final formulation of internal curing system includes:
between about 40 M.-% and 70% M.-% of water,
between about 0.05 M.-% and 0.5 M.-%, of viscosity modifier
between about 10.0 M.-% and 30.0 M.-% of inorganic salt, and
between about 5.0 M.-% and 20.0 M.-%. of SAP, wherein M.% refers to mole percent.

Advantageously, the final formulation of internal curing system may be a suspension having a viscosity of about 300 to 400 MPa*s. The viscosity of the suspension ensures that the polymers do not precipitate, guaranteeing the stability of the aqueous internal curing system mix.

The internal curing system can be used as additive in cementitious mixtures up to 6 months after its formulation.

The cementitious material mix according to some embodiments may also contain conventional additives used in construction materials, such as water reducers, plasticizers or superplasticizers, accelerators, retarders, air entrainers, defoamers or any other admixture, structural fiber reinforcement, both inorganic (metal, mineral, carbon, etc.) and/or organic.

Possibly or preferably, the cementitious material mix produced (concrete or mortar) contains a total binder amount located between 290 Kg/m³ and 800 Kg/m³per cubic meter of fresh produced castable material (concrete or mortar) and the total binder contains at least 40% Portland Clinker in weight.

Advantageously, ranges for w/b (water to binder ration) are between 0.25 and 0.7. Typically high values of w/b ratio (above 0.4) are used for screeds and mortars, whereas concrete designs may have w/b ratio located between 0.25 and 0.55.

Advantageously, the average quantity of sand is typically between 500 and 1600 Kg per cubic meter of fresh produced castable material.

Advantageously, the average quantity of fine aggregates (when used) is typically between 200 and 1000 Kg per cubic meter of fresh produced castable material (concrete or mortar).

Advantageously, the average quantity of coarse aggregates (when used) is typically between 250 and 900 Kg per cubic meter of fresh produced castable material.

### EXAMPLES

Examples 1-7 are provided for concrete screed and mortar according to the first and second embodiment of the presently disclosed subject matter and mortars (respectively using the components of the internal curing system formulated in an admixture).

The cements used are of type Portland cement type I, II (EN Norms).Sand, fine size aggregates and large size aggregates are either round or crushed.

Mortars have been mixed using standard EN Mortar mixers and concrete samples have been mixed using conventional concrete mixers with capacity from 10 liters to 1 cubic meter.

Flow measurements were performed on cone test and standard spread metallic plate. Strength measurements on mortars were done on 4×4×16 cm standard samples and concrete samples are tested on cubes (15×15×15 cm) or cylinders (diam. 15 cm height 30 cm).

The self curing behavior or the shrinkage resistance was measured using cracking tests. The crack test carried out in the examples that follow was a modification of the norm ASTM C1579-2006 and is shown in table 3.

The crack test is an evaluation of the plastic shrinkage of mortar or concrete in severe conditions of curing: high temperature (about 40t) and dry environment (11-15% RH) and forced strong ventilation (about 5 m/sec).

The test was done by casting a concrete or a mortar in a 38 cm×24 cm×7 in a mould and placing the mould in a wood hot box (environmental chamber) for 24 hours. A stress riser, made of steel, with internal restraint was placed at the bottom of the mould.

Before placing the moulds in the hot box, a surface finishing has to be made, normally by a trowel or a metal straightedge.

In the hot box, two heating fans were used to produce a temperature of about 40° C. and a air speed of about 5 m/sec on the top surface of the moulds placed inside.

After 24 h from initial mixing, the area of the cracks that form on the surface was registered. The length and the width of the cracks were measured to calculate the area of the cracks. Instead of registering the area of the cracks, the minimum and maximum width of the central crack can be measured, which provides a range of the width appeared on the surface of the mortar/concrete.

Comparison of the modified crack test with the norm is shown in Table 3:

TABLE 3
description of the modified crack test used to characterize the resistance to
shrinkage and the effect of the internal curing system.

| | ASTM C1579 | Modified crack test |
|---|---|---|
| Use | Fiber reinforced concrete (FRC) | All types of mortar and |
| | | concrete |
| Dimension of the | 2 times 56 × 35.5 × 10 cm | 3 times 38 × 24 × 7 cm or |
| test panels | | 1 time 77 × 44 × 7 cm |
| Big stress height | 6.35 cm | 4.50 cm |
| Hot box | Monitor systems of evaporation rate, airflow, | No monitor systems |
| | setting time | |
| | Hot box for 2 panels test | Hot box for 3 panels test |
| Temperature | 36° C. | 42° C. |
| Relative Humidity | 30% | 10% |
| Wind velocity | to have an evaporation rate of 1.0 Kg/m2 × h | 5-7 m/s |
| Procedure | Test stops at the final setting time and the | Test stops at 24 h. |
| | panels test are stored until 24 h at 20° C. | |
| | under plastic sheets. | |
| Results | Cracking reduction ratio (CRR) at 24 h: | Width range of cracking at |
| | (1 − ((average crack width of FRC mix)/ | 24 h |
| | (average crack width of control mix))) × 100 | |

The ring test is t is a modification of the standard ring test: ASTM C1581-04.

This method determines the age of cracking and induced tensile stress characteristics of mortar and concrete specimens under restrained shrinkage.

A sample of freshly mixed mortar or concrete is compacted in a circular mould around a steel ring. The restrained shrinkage behavior of concrete or mortar from the time of demoulding is monitored continuously by a system of strain gauges that measures the deformation of the material in time. Cracking of the test specimen is indicated by a sudden variation of the displacement value recorded by the strain gauges.

The age at cracking indicates the materials resistance to cracking under restrained shrinkage.

The test enables a measurement of the material deformation coupled with cracking behavior. The apparatus used I a steel mould consisting in a steel base, an inner steel ring and an outer ring (composed of 2 parts).

For mortar:

Mould: 16 mm thickness

Inner ring: 106 mm internal diameter; 130 mm external diameter; 67 mm height

Steel base: 82 mm internal diameter; 162 mm external diameter; 20 mm height

Outer ring: 162 mm internal diameter; 87 mm height

For concrete:

Mould: 40 mm thickness

Inner ring: 294.6 mm internal diameter; 320.1 mm external diameter; 165 mm height

Steel base: 400.1 mm internal diameter; 460 mm external diameter; 15 mm height

Outer ring: 400 mm internal diameter; 165 mm height

Procedure used:
Oil the surface of the moulds and cast the material into them.
At the time of demoulding, remove the two parts of the outer ring and the mould base from the concrete or mortar ring.
Seal the bottom of the ring with paraffin wax or an adhesive aluminum foil tape.
Place the ring in a flat support and glue the gauges (2-3).
Seal the top with the same sealing agent use for the bottom. This operation allows having the drying of the material only from the external surface of the ring.
Start the record of the gauges (one measurement every 5-30 minutes)
A sudden decrease in the displacement measurement indicates cracking. The sudden decrease is usually about 10 microns of displacement for mortar specimen and about 2-6 microns of displacement for concrete specimen.
The text is stopped at 28 days if no cracks were detected.

### Comparative Example 1

A cementitious mix for concrete application was designed, using a superabsorbent polymer in powder as internal curing agent.

Four mixes were designed, including one reference—where no SAP was used, therefore no internal formulated curing system was added—and three tests wherein three different concentrations of powdered SAP were adjoined.

The four mix designs are represented in table 4.

TABLE 4
Mix designs for Example 1, wherein the behavior
of powdered SAP was observed

| | MIX DESIGN | | | | |
|---|---|---|---|---|---|
| | | Reference | Test 1 | Test 2 | Test 3 |
| OPC CEM I 52.5 R | kg/m³ | 350 | 350 | 350 | 350 |
| Water | kg/m³ | 180 | 180 | 180 | 180 |
| w/c | — | 0.51 | 0.51 | 0.51 | 051 |
| Paste Volume | l/m³ | 291 | 291 | 291 | 291 |
| Sand | kg/m³ | 890 | 890 | 890 | 890 |
| Coarse Aggregate | kg/m³ | 390 | 390 | 390 | 390 |
| (4.8 mm) | | | | | |
| Coarse Aggregate | kg/m³ | 480 | 480 | 480 | 480 |
| (8.16 mm) | | | | | |
| Superplasticizer | % binder | 0.59 | 0.59 | 0.59 | 059 |
| | kg/m³ | 2.07 | 2.07 | 2.07 | 2.07 |
| Superabsorbent | kg/m³ | — | 0.50 | 1.50 | 5.00 |
| (Powder) | | | | | |
| RESULTS | | | | | |
| Slump Test | mm | 190 | 140 | 90 | 45 |
| Slump Class | — | S4 | S3 | S2 | S2 |
| Plastic shrinkage - | | | | | |
| Crack test | | | | | |
| crack | — | YES | YES | YES | NO |
| crack width | mm | 1.8 | 1.6 | 0.8 | — |
| Restrained | | | | | |
| shrinkage - Ring test | | | | | |
| Days for Cracking | — | 3 | 5 | 8 | |

As one can see from Table 4, SAPs are effective as internal curing agents—while the Reference cementitious mix, in the crack test, experienced plastic shrinkage cracking, the cementitious mix 3, where 5 kg/m³ of SAP was added, had no cracks at the end of the crack test.

Also, the samples with SAP performed better in the Ring test—while the Reference sample cracked just after 3 days, sample 3 had no cracking due to restrained shrinkage.

Despite the good and encouraging results obtained with the use of powder SAPs as internal curing agents, once the powdered SAP was introduced in the mix, it became stiff, having very reduced workability, due to the fast water uptake from the SAP and consequent swelling of the polymer. In fact, using the same mix design, the castable material produced went from a S4 to a S2 due to the water uptake by the superabsorbent. The possible solution of increasing the dosage of superplasticizer alters the characteristics of the material, hence undermining the quality of the final product, and therefore it should be avoided.

Despite the good results of using SAPs internal curing agents, the use of powdered material in real applications poses several constraints, namely due to reduced workability of the material after SAP addition.

### Example 2

This example shows the procedure to formulate the internal curing system, according to one embodiment of the presently disclosed subject matter.

Water and a polysaccharide were mixed together in a vessel under continuous stirring. The mixing of the two ingredients continued for 2 hours, during the 2 hours the viscosity of the mix slightly increased. After the 2 hours, and still under continuous mixing, aluminium sulphate (Al₂(SO₄)₃) was added. Due to the ionic dissociation of the salt introduced, the viscosity of the mix suffered a sharp increase, reaching a peak close to 1200 MPa·s. After this peak, the viscosity of the peak lowered, reaching about 200 MPa·s. Around this time, more specifically 140 minutes after the beginning of the preparation of the formulation, a superabsorbent polymer was introduced in the mix.

The final mix had a milky consistency due to the polymer suspension, nevertheless no segregation or precipitation of the polymer was observed. The mix remained stable for 6 months.

The final mole percentages of the different components added during the formulation were included in the following ranges:

TABLE 5
Different ranges of the components used in the
internal curing system formulation

| | |
|---|---|
| Water | 60-70% |
| Polysaccharide | 0.1-0.5% |
| Al₂(SO₄)₃ | 17-25% |
| SAP | 7-25% |
| Total | 100% |

For example:

| | |
|---|---|
| Water | 60.00% |
| Polysaccharide | 0.10% |
| Al₂(SO₄)₃ | 19% |
| SAP | 21% |
| Total | 100% |

### Example 3

The third example demonstrated the effect of different SAPs concentration in a concrete application.

The internal curing system dry solid content formulated in example 2 was used in this example in different percentages of binder: 0.3%, 0.6% and 1.1% (all dry solid contents, weight % with respect to the total binder content). Table 6 shows the different results obtained:

TABLE 6
Mix designs for a concrete application using 3
different concentrations of the internal curing
system dry solid content of Example 2

| | MIX DESIGN | | | | |
|---|---|---|---|---|---|
| | | Reference | Test 1 | Test 2 | Test 3 |
| OPC Cem I-52.5 | kg/m³ | 300 | 300 | 300 | 300 |
| Water | kg/m³ | 165 | 165 | 165 | 165 |
| w/c | — | 0.55 | 0.55 | 0.55 | 0.55 |
| Paste Volume | l/m³ | 260 | 260 | 260 | 260 |
| Sand | kg/m³ | 870 | 870 | 870 | 870 |
| Fine Aggregates | kg/m³ | 480 | 480 | 480 | 480 |
| Coarse Aggregates | kg/m³ | 560 | 560 | 560 | 560 |
| Superplasticizer | % binder | 0.7 | 0.7 | 0.7 | 0/ |
| Internal Curing | kg/m³ | — | 0.83 | 1.65 | 3.30 |
| System | % binder | — | 0.3 | 0.6 | 1.1 |
| Results: | | | | | |
| Slump | mm | 190 | 190 | 190 | 175 |
| Slump Class | — | S4 | S4 | S4 | S4 |
| Plastic shrinkage - | | | | | |
| Crack test | | | | | |
| crack | — | YES | YES | YES | NO |
| crack width | mm | 0.35 | 0.45 | 0.25 | — |

Compared to the first example presented in the presently disclosed subject matter, the use of a formulated internal curing system didn't affect dramatically the slump of the concrete. The concrete remained a S4, even when 1.1% of dry solid content in the formulated internal curing system related to the binder content was added in the mix.

The crack test also revealed smaller cracks with the use of the formulated internal curing system. While in the reference sample, one had cracks with a maximum width of 0.35 mm, test 3 resulted in no cracks. Furthermore, the cracks obtained in test 2 had a smaller width than the one obtained in the reference test.

### Example 4

In this example, one wanted to confirm the efficiency of the internal curing system formulated in example 2 in a concrete mix where other supplementary cementitious materials, in addition to Portland cement, were used, namely slag and lime filler. Again, different percentages of dry solid content of internal curing system were added, namely 0.3%, 0.5% and 1.1% related to the % of total binder used.

TABLE 7
Mix designs for example 4

| | MIX DESIGNS | | | | |
|---|---|---|---|---|---|
| | | Reference | Test 1 | Test 2 | Test 3 |
| OPC Cem I 42.5 | kg/m³ | 210 | 210 | 210 | 210 |
| Slag | kg/m³ | 90 | 90 | 90 | 90 |
| Lime Filler | kg/m³ | 10 | 10 | 10 | 10 |
| Water | kg/m³ | 161 | 161 | 161 | 161 |
| w/b | — | 0.52 | 0.52 | 0.52 | 0.52 |
| Paste Volume | l/m³ | 306 | 306 | 306 | 306 |
| Sand | kg/m³ | 860 | 860 | 860 | 860 |
| Fine Aggregates | kg/m³ | 475 | 475 | 475 | 475 |
| Coarse Aggregates | kg/m³ | 570 | 570 | 570 | 570 |
| Superplasticizer | % binder | 0.7 | 0.7 | 0.7 | 0.7 |
| Internal Curing | kg/m³ | — | 0.825 | 1.65 | 3.3 |
| System | % binder | — | 0.3 | 0.5 | 1.1 |
| Results: | | | | | |
| Slump | mm | 200 | 210 | 190 | 190 |
| Slump Class | — | S4 | S4 | S4 | S4 |
| Plastic shrinkage - | | | | | |
| Crack test | | | | | |
| crack | — | YES | YES | YES | NO |
| crack width | mm | 0.6 | 0.55 | 0.35 | 0 |

Once again, the slump of the final concrete was not significantly affected by the inclusion of the internal curing system formulated according to the presently disclosed subject matter.

After carrying on the crack test, one observed a reduction in the maximum crack width when higher dosage (in dry solid content) of formulated internal curing system was added; in fact, using 1.1% of formulated internal curing agent lead to no cracking of the material due to plastic shrinkage.

### Example 5

Example 5 was carried out to investigate how the internal curing system of Example 2 would perform in screed applications.

The mix design for this test is detailed in Table 8.

TABLE 8
Mix design for screed application

| | MIX DESIGN | | |
|---|---|---|---|
| | | Blank | Test Screed |
| OPC CEM I 52.5 R | kg/m³ | 517 | 517 |
| Water | kg/m³ | 256 | 256 |
| w/c | — | 0.50 | 0.50 |
| Paste Volume | l/m³ | 420 | 420 |
| Sand 0/4 mm crushed | kg/m³ | 695 | 695 |
| Sand 0/4 mm round | kg/m³ | 737 | 737 |
| Superplasticizer | % binder | 0.7 | 0.7 |
| | kg/m³ | 3.41 | 3.41 |
| Internal Curing System | kg/m³ | | 4.3 |
| | % binder | | 0.83 |
| Results: | | | |
| Slump | mm | 260 | 255 |
| Slump Class | — | S5 | S5 |
| Plastic shrinkage - Crack test | | | |
| crack | — | YES | NO |
| crack width | mm | 1.15 | — |

It is observed that the internal curing system is also effective in highly fluid mixes, such as for screed applications, maintaining the slump while reducing the plastic shrinkage cracking.

### Example 6

The internal curing system of Example 2 was also tested in a very fluid mix designed to optimize the self-placing properties of the final product.

The mix design used and results obtained are compiled in Table 9.

TABLE 9
Mix design for fluid concrete

| | MIX DESIGNS | | |
|---|---|---|---|
| | | Reference | Test 1 |
| OPC Cement type II | kg/m³ | 350 | 350 |
| Aggregates 4/8 mm | kg/m³ | 448 | 448 |
| Aggregates 8/16 mm | kg/m³ | 672 | 672 |
| Sand 0/4 mm | kg/m³ | 1120 | 1120 |
| Water | kg/m³ | 175 | 175 |
| Superplasticiser | % binder | 0.8 | 0.8 |
| Internal Curing System | % binder | | 0.6 |
| | kg/m³ | | 2.1 |
| RESULTS | | | |
| Fresh properties | | | |
| Slump flow | mm | 550 | 620 |
| Slump Class | — | SF1 | SF1 |
| Restrained shrinkage - Ring test | | | |
| time of crack | h | 171 | >250 |
| Compressive strength | | | |
| 28 days | Mpa | 63.78 | 62.86 |

One can see that the slump was not influenced by the addition of the internal curing system used while the time of cracking in the Ring test was much higher when the internal curing system was used (more than 250 hours to crack, compared to the reference that took only 171 hours).

### Example 7

To understand how the formulation would affect a concrete mix design having a high content of binder, example 7 was carried out using a total of 436 l/m³ of paste volume, including 400 kg/m³ of Cement type II and 185 kg/m³ of fly ash. The amount of dry solid content of the internal curing system was increased to 2% of weight of binder.

TABLE 10
Mix design and results obtained for Example 7

| | MIX DESIGNS | | |
|---|---|---|---|
| | | Reference | Test 1 |
| OPC Cement type II | kg/m³ | 400 | 400 |
| Fly Ash | kg/m³ | 185 | 185 |
| Aggregates 4/8 mm | kg/m³ | 294 | 294 |
| Aggregates 8/16 mm | kg/m³ | 515 | 515 |
| Sand 0/4 mm | kg/m³ | 659 | 659 |
| Water | kg/m³ | 215 | 215 |
| Paste Volume | l/m³ | 436 | 436 |
| Superplasticiser (ASC) | % binder | 0.9 | 0.9 |
| Internal Curing System (ASC) | % binder | — | 2 |
| | kg/m³ | — | 11.7 |
| RESULTS | | | |
| Fresh properties | | | |
| Slump flow | mm | 720 | 725 |
| Slump Class | — | SF2 | SF2 |
| Restrained shrinkage - Ring test | | | |
| time of crack | h | 48 | >672 |
| Compressive strength | | | |
| 28 days | Mpa | 65.7 | 64.1 |

One can see that the slump is not affected by the use of the internal curing system. Also, the Ring Test results are better when the internal curing system formulation is added—after 28 days the concrete had not cracked when the internal curing system was used, while when no internal curing system was added, the concrete cracked after 48 hours.

1. A cementitious material mix design, comprising:
(a) a cementitious binder that contains an Ordinary Portland Cement, the binder content per cubic meter of fresh produced castable material (concrete or mortar) being at least 290 kg;
(b) sand, the sand content per cubic meter of fresh concrete or mortar being between 500 kg and 1600 kg;
(c) water, wherein the water to total binder ratio is between 0.25 and 0.7 by weight;
(d) a self-curing system; and
(e) a volume of paste in an amount of at least 250 l per cubic meter of fresh concrete or mortar;
wherein, the internal curing system includes a mixture of a superabsorbent polymer, a viscosity modifier and an inorganic salt, in water.

2. The cementitious material mix design according to claim 1, further comprising fine and/or coarse aggregates.

3. The cementitious material mix design according to claim 1, wherein the internal curing system is present in an amount so that the dry solid content of the internal curing system is between 0.2% and 2.2%, wherein the dry solid content is expressed in weight % with respect to the total binder.

4. The cementitious material mix design according to claim 1, wherein the internal curing system comprises between about 40 M.-% and 70% M.-% of water, between about 0.05 M.-% and 0.5 M.-% of viscosity modifier, between about 10.0 M.-% and 30.0 M.-% of inorganic salt between about 5.0 M.-% and 20.0 M.-% of superabsorbent polymer.

5. The cementitious material mix design according to claim 1, wherein the viscosity modifier agent is chosen from polysaccharides, polymers of acrylic acid and co-polymers thereof, polyethylene and related copolymers, alkylene oxide polymers and esters thereof, and methyl vinyl ether/maleic anhydride copolymers crosslinked with decadiene.

6. The cementitious material mix design according to claim 1, wherein the cation of the inorganic salt has a valence between 1 and 3.

7. The cementitious material mix design according to claim 1, wherein the superabsorbent polymer in the internal curing system is a potassium-based superabsorbent.

8. A method of using an aqueous suspension of super absorbent polymer for increasing shrinkage resistance of cementitious material mix design.

9. A method for producing a stable aqueous suspension of super absorbent polymer, comprising:
mixing a viscosity modifier agent with water;
adding a suitable inorganic salt and mixing for a time t that is at least 30 minutes; and
adding the superabsorbent polymer to form an aqueous suspension.
